(19) United States
(12) Patent Application Publication
(10) Pub. No.: US 2005/0248700 A1
(43) Pub. Date: Nov. 10, 2005

(54) Substrate for liquid crystal display and liquid crystal display having the same

(75) Inventors: Takashi Takagi, Kawasaki (JP); Atsuyuki Hoshino, Kawasaki (JP); Manabu Sawasaki, Kawasaki (JP); Takuya Saguchi, Yonago (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/651,579

(22) Filed: Aug. 29, 2003

(30) Foreign Application Priority Data
Aug. 30, 2002 (JP) 2002-253823

(51) Int. Cl. G02F 1/1333

(52) U.S. Cl. 349/110; 349/113

(57) ABSTRACT

The invention relates to a liquid crystal display used in a display section of an electronic apparatus and a liquid crystal display substrate used for the same and provides a liquid crystal display that can be manufactured through simplified manufacturing processes and that can provide high display quality and a liquid crystal display substrate used for the same. A configuration is employed which includes gate bus lines and drain bus lines formed on a substrate such that they intersect each other with an insulation film interposed therebetween and pixel electrodes provided so as to cover at least one of the gate bus lines and the drain bus lines with a dielectric layer interposed therebetween and forming parasitic capacities between the gate bus lines or drain bus lines and themselves.

### BACKGROUND OF THE INVENTION

1. Field of the Invention

The present invention relates to a liquid crystal display used for a display section of an electronic apparatus and a substrate for a liquid crystal display used for such a display.

2. Description of the Related Art

In general, an active matrix liquid crystal display has a TFT substrate on which a thin film transistor (TFT) is formed at each pixel as a switching element and an opposite substrate on which color filters (CF) are formed.

The TFT substrate has gate bus lines and drain bus lines that intersect each other with an insulation film interposed therebetween. TFTs are formed in the vicinity of the positions where the bus lines intersect. A pixel electrode is formed at each of a plurality of pixel regions that are arranged in the form of a matrix.

For example, the TFT substrate is patterned using the separate exposure method utilizing a stepper. According to the separate exposure method, a display area in which a repetitive pattern of TFT arrays is formed is divided into a plurality of exposure areas, and each of the exposure areas is sequentially exposed using the same mask. In a boundary between two adjoining exposure areas, edges of the exposure areas overlap each other. However, when a misalignment occurs between shots at the time of the separate exposure (a misalignment in an X-Y direction or a misalignment in a rotating direction), either of the shots exposes a greater area in the boundary region. As a result, the width of a wiring or electrode formed at the boundary becomes small when the photo-resist used is a positive resist which dissolves during development in exposed regions thereof. Conversely, the width of a wiring or electrode formed at the boundary becomes great when a negative resist is used which survives during development in exposed regions thereof.

FIG. 22 shows a configuration of a TFT substrate according to the related art. FIG. 23 is a sectional view of the TFT substrate taken along the line X-X in FIG. 22. As shown in FIGS. 22 and 23, a plurality of gate bus lines 112 extending in the horizontal direction of FIG. 22 are formed in parallel with each other on a glass substrate 110 that constitutes a TFT substrate 102. An insulation film 130 is formed on the gate bus lines 112 throughout the substrate. A plurality of drain bus lines 114 extending in the vertical direction of FIG. 22 are formed in parallel with each other such that they intersect the gate bus lines 112 with the insulation film 130 interposed therebetween. A protective film 132 is formed on the drain bus lines 114. An overcoat layer (a leveling film) 134 made of a transparent photosensitive resin is formed on the protective film 132.

Pixel electrodes 116 are formed in regions surrounded by the gate bus lines 112 and the drain bus lines 114 on the overcoat layer 134. The regions where the pixel electrodes 116 are formed serve as pixel regions. TFTs 120 are formed in the vicinity of positions where the gate bus lines 112 and the drain bus lines 114 intersect. Gate electrodes of the TFTs 120 are electrically connected to the gate bus lines 112. Drain electrodes 121 of the TFTs 120 are electrically connected to the drain bus lines 114. Source electrodes 122 of the TFTs 120 are electrically connected to the pixel electrodes 116 through contact holes 124.

A plurality of storage capacitor bus lines 118 extending across the pixel regions are formed on the TFT substrate 102 in parallel with the gate bus lines 112. A storage capacitor electrode (intermediate electrode) 119 is formed on the storage capacitor bus line 118 in each of the pixel regions. The storage capacitor electrodes 119 are electrically connected to the pixel electrodes 116 through contact holes 126.

Predetermined parasitic capacities are generated between a drain bus line 114 and pixel electrodes 116 that are formed in the vicinity of edges of the drain bus line 114 on both sides thereof with the protective film 132 and the overcoat layer 134 that are dielectric layers interposed between them. Similarly, predetermined parasitic capacities are generated between a gate bus line 112 and pixel electrodes 116 that are formed in the vicinity of edges of the gate bus line 112 on both sides thereof with the insulation film 130, the protective film 132 and the overcoat layer 134 that are dielectric layers interposed between them.

FIGS. 24A to 24C show sectional configurations of a TFT substrate 102 in other regions thereof. FIG. 24A shows a TFT substrate 102 on which a relative misalignment (a misregistration) has occurred between a drain bus line 114 and pixel electrodes 116. As shown in FIG. 24A, the pixel electrodes 116 are formed with a rightward shift relative to the drain bus line 114. As a result, the distance between the edge of the pixel electrode 116 on the right and the edge of the drain bus line 114 is greater than that in the section shown in FIG. 23, and the distance between the edge of the pixel electrode 116 on the left and the edge of the drain bus line 114 is smaller than that in section in FIG. 23.

FIGS. 24B and 24C show sectional configurations of a boundary section of a TFT substrate 102 on which a misalignment has occurred at each shot of exposure during patterning of the pixel electrodes 116. Referring to FIG. 24B, the pixel electrodes 116 are formed with a great width in the horizontal direction of the figure because of a misalignment at each shot. As a result, the distances between the edges of the pixel electrodes 116 and the edges of the drain bus line 114 are narrow. Referring to FIG. 24C, the pixel electrodes 116 are formed with a narrow width in the horizontal direction of the figure because of a misalignment at each shot. As a result, the distances between the edges of the pixel electrodes 116 and the edges of the drain bus line 114 are wide.

Such a difference between the distances between the pixel electrodes 116 and the drain bus line 114 result in a difference between parasitic capacities generated between the pixel electrodes 116 and the drain bus line 114. When there is a region having a parasitic capacity different from others in the display area, the region will have different display characteristics. For example, when there is a difference between parasitic capacities at a boundary between two exposure areas adjacent to each other in the horizontal direction of the display screen, the boundary will be visually perceived as a display irregularity in the form of a straight line extending in the vertical direction of the display screen. When each exposure area has a different parasitic capacity, each exposure area has different display characteristics, which will be visually perceived as display irregularities.

One method for solving the above-described problem is to form the overcoat layer 134 made of a photosensitive resin with a greater thickness. FIG. 25 is a sectional view showing a configuration of a TFT substrate 102 having an overcoat layer 134 formed with a greater thickness. As shown in FIG. 25, an overcoat layer 134 formed with a greater thickness results in greater distances between edges of pixel electrodes 116 and edges of a drain bus line 114 to generate smaller parasitic capacities. When the overcoat layer 134 is formed with a great thickness such that resultant parasitic capacities are negligibly small, no display irregularity as described above is visually perceived even if a misalignment occurs.

Since the pixel electrodes 116 can be formed such that they overlap the drain bus lines 114 and gate bus lines 112 in this configuration, an improved aperture ratio can be achieved (for example, see Articles 1 and 2 described below). Further, the pixel electrodes 116 can be formed such that they cover the drain bus lines 114, gate bus lines 112 and TFTs 120 (for example, see Article 3 described below).

FIG. 26 shows a configuration of a substrate for a liquid crystal display to be used for MVA (multi-domain vertical alignment) mode liquid crystal displays according to the related art. As shown in FIG. 26, a TFT substrate 102 has linear protrusions 140 and 141 as alignment regulating structures for regulating the alignment of a liquid crystal having negative electric constant anisotropy. The linear protrusions 140 are formed above storage capacitor bus lines 118 and storage capacitor electrodes 119 such that they extend in the horizontal direction of the figure. The linear protrusions 141 are formed substantially in the middle of pixel regions such that they extend in the vertical direction of the figure. The linear protrusions 140 and 141 are formed of a resist.

(Reference Documents)

Article 1: Japanese Patent Laid-Open No. JP-A-11-148078 (pp. 4-6, FIG. 1)
Article 2: Japanese Patent Laid-Open No. JP-A-9-152625 (pp. 8-10, FIG. 1)
Article 3: Japanese Patent Laid-Open No. JP-A-9-138423 (pp. 2-4, FIG. 1)

Since a common resin has a relative dielectric constant in the range from 3 to 4, the overcoat layer 134 must be formed with a great thickness in the range from 3 to 5 μm in order that the parasitic capacities generated will be negligibly small. As a result, a greater exposure energy and a longer exposure time is required when contact holes are formed by providing openings in the overcoat layer 134. This results in a problem in that processes for manufacturing the TFT substrate 102 become complicated to reduce productivity. Problems also arise in that the resolution of patterning is reduced and in that undeveloped regions can remain.

In the case of the liquid crystal display having alignment regulating structures, since the aperture ratio is reduced by the linear protrusions 141 formed in the pixel regions, a problem arises in that the display luminance of the liquid crystal display is reduced. The luminance of a backlight must be increased to maintain the display luminance, which results in a problem in that the power consumption of the liquid crystal display is increased.

### SUMMARY OF THE INVENTION

It is an object of the invention to provide a liquid crystal display which can be manufactured through simplified processes and which can provide high display quality and a liquid crystal display substrate used for the same.

The above object is achieved by a substrate for a liquid crystal display, characterized in that it includes a base substrate that sandwiches a liquid crystal in combination with an opposite substrate provided opposite to the same, first and second bus lines formed on the base substrate such that they intersect each other with an insulation film interposed therebetween, and a pixel electrode provided so as to cover at least either of the first and second bus lines with a dielectric layer interposed therebetween and forming a parasitic capacity between the first or second bus line and itself.

### BRIEF DESCRIPTION OF THE DRAWINGS

FIG. 1 shows a schematic configuration of a liquid crystal display according to a first embodiment of the invention;

FIG. 2 shows a configuration of a substrate for a liquid crystal display according to the first embodiment of the invention;

FIGS. 3A and 3B are sectional views showing the configuration of the substrate for a liquid crystal display according to the first embodiment of the invention;

FIG. 4 shows a method of manufacturing a substrate for a liquid crystal display according to the first embodiment of the invention;

FIG. 5 is a sectional view taken in a process illustrating the method of manufacturing a substrate for a liquid crystal display according to the first embodiment of the invention;

FIG. 6 shows the method of manufacturing a substrate for a liquid crystal display according to the first embodiment of the invention;

FIG. 7 is a sectional view taken in a process illustrating the method of manufacturing a substrate for a liquid crystal display according to the first embodiment of the invention;

FIG. 8 shows a configuration of a substrate for a liquid crystal display according to a second embodiment of the invention;

FIG. 9 shows a modification of the configuration of a substrate for a liquid crystal display according to the second embodiment of the invention;

FIG. 10 is a sectional view showing the modification of the configuration of a substrate for a liquid crystal display according to the second embodiment of the invention;

FIG. 11 shows a configuration of a substrate for a liquid crystal display according to a third embodiment of the invention;

FIG. 12 is a sectional view showing the configuration of the substrate for a liquid crystal display according to the third embodiment of the invention;

FIG. 13 shows a method of manufacturing a substrate for a liquid crystal display according to the third embodiment of the invention;

FIG. 14 is a sectional view taken in a process showing the method of manufacturing a substrate for a liquid crystal display according to the third embodiment of the invention;

FIG. 15 shows the method of manufacturing a substrate for a liquid crystal display according to the third embodiment of the invention;

FIG. 16 is a sectional view taken in a process showing the method of manufacturing a substrate for a liquid crystal display according to the third embodiment of the invention;

FIG. 17 shows a modification of the configuration of a substrate for a liquid crystal display according to the third embodiment of the invention;

FIGS. 18A and 18B are sectional views showing the modification of the configuration of a substrate for a liquid crystal display according to the third embodiment of the invention;

FIG. 19 shows a configuration of a substrate for a liquid crystal display according to a fourth embodiment of the invention;

FIG. 20 shows a method of manufacturing a substrate for a liquid crystal display according to the fourth embodiment of the invention;

FIG. 21 shows a configuration of a substrate for a liquid crystal display according to a fifth embodiment of the invention;

FIG. 22 shows a configuration of a substrate for a liquid crystal display according to the related art;

FIG. 23 is a sectional view showing the configuration of the substrate for a liquid crystal display according to the related art;

FIGS. 24A to 24C are sectional views illustrating problems with the substrate for a liquid crystal display according to the related art;

FIG. 25 is a sectional view showing another configuration of a substrate for a liquid crystal display according to the related art; and

FIG. 26 shows still another configuration of a substrate for a liquid crystal display according to the related art.

### DESCRIPTION OF THE PREFERRED EMBODIMENTS

[First Embodiment]

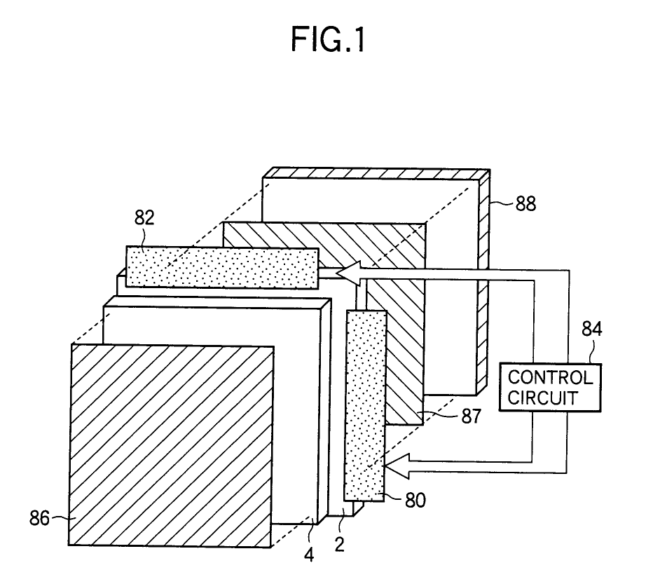

A description will now be made with reference to FIGS. 1 to 7 on a substrate for a liquid crystal display and a liquid crystal display having the same according to an embodiment of the invention. FIG. 1 shows a schematic configuration of a liquid crystal display according to the present embodiment. As shown in FIG. 1, the liquid crystal display has structure in which a TFT substrate (base substrate) 2 having a pixel electrode and a TFT formed in each of pixel regions and an opposite substrate 4 having a common electrode formed thereon are combined in a face-to-face relationship to seal a liquid crystal between them. Alignment films for aligning liquid crystal molecules in a predetermined direction are formed on surfaces of the substrates 2 and 4 opposite to each other.

The TFT substrate 2 is provided with a gate bus line driving circuit 80 having driver ICs for driving the plurality of gate bus lines mounted thereon and a drain bus line driving circuit 82 having driver ICs for driving the plurality of drain bus lines mounted thereon. The driving circuits 80 and 82 output scan signals or data signals to predetermined gate bus lines or drain bus lines based on predetermined signals output by a control circuit 84.

A polarizer 87 is applied to a surface of the TFT substrate 2 opposite to a surface on which elements are formed. For example, a backlight unit 88 constituted by a linear primary light source and a planar light guide plate is provided on the side of the polarizer 87 opposite to the TFT substrate 2. A polarizer 86 is applied to a surf ace of the opposite substrate 4 that is opposite to a surface on which a common electrode is formed.

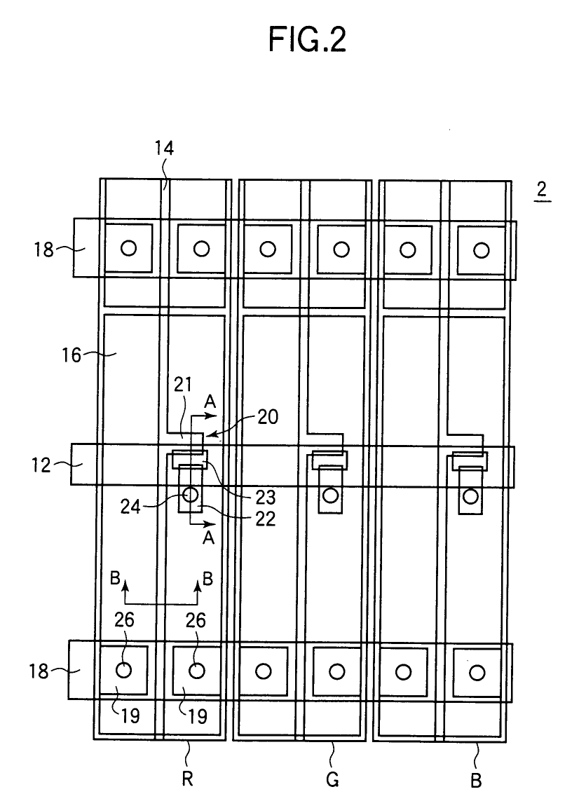

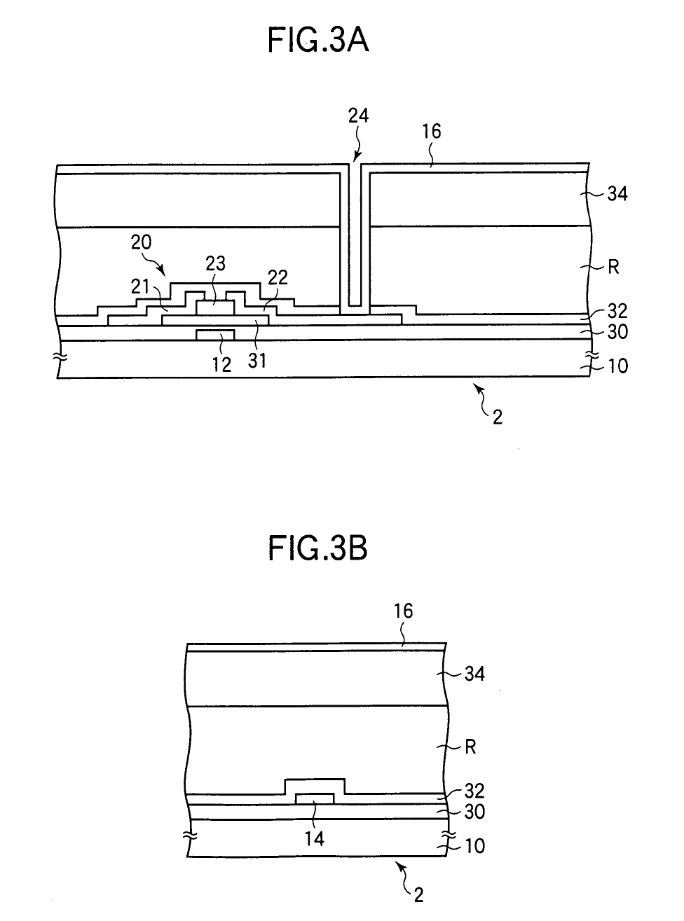

FIG. 2 shows a configuration of the TFT substrate according to the present embodiment. FIG. 3A is a sectional view of the TFT substrate taken along the line A-A in FIG. 2, and FIG. 3B is a sectional view of the TFT substrate taken along the line B-B in FIG. 2. As shown in FIGS. 2 to 3B, the liquid crystal display of the present embodiment has a CF-on-TFT structure in which CF layers are formed on the TFT substrate 2. A plurality of gate bus lines 12 extending in the horizontal direction of FIG. 2 are formed in parallel with each other on a glass substrate 10 that constitutes the TFT substrate 2. An insulation film 30 is formed on the gate bus lines 12 throughout the substrate. A plurality of drain bus lines 14 extending in the vertical direction of FIG. 2 are formed in parallel with each other on the insulation film 30 such that they intersect the gate bus lines 12 with the insulation film 30 interposed therebetween. A protective film 32 is formed on the drain bus lines 14 throughout the substrate.

CF resin layers in any of red (R), green (G) and (B) are formed on the protective layer 32. An overcoat layer 34 that is a resin insulation film made of a transparent photosensitive resin is formed on the CF resin layers R, G and B. Pixel electrodes 16 made of a light-transmitting electrode material such as ITO (indium tin oxide) is formed such that they cover the gate bus lines 12 and the drain bus lines 14. The pixel electrodes 16 are provided such that they overlap the drain bus lines 14 substantially in the middle thereof when viewed in a direction perpendicular to the substrate surface. The regions where the pixel electrodes 16 are formed serve as pixel regions. Predetermined parasitic capacities are generated between the pixel electrodes 16 and the gate bus lines 12 or the drain bus lines 14.

TFTs 20 are formed in the vicinity of positions where the gate bus lines 12 and the drain bus lines 14 intersect. Gate electrodes of the TFTs 20 are electrically connected to the gate bus lines 12. Drain electrodes 21 of the TFTs 20 are electrically connected to the drain bus lines 14. Source electrodes 22 of the TFTs 20 are electrically connected to the pixel electrodes 16 through contact holes 24 formed by providing openings in the overcoat layer 34, the CF layers and the protective film 32 on the source electrodes 22.

A plurality of storage capacitor bus lines 18 are formed on the TFT substrate 2 in parallel with the gate bus lines 12. Storage capacitor electrodes 19 are formed on the storage capacitor bus lines 18. Two storage capacitor electrodes 19 are formed in each of the pixel regions, and one each of them is provided on both sides of a drain bus line 14. The storage capacitor electrodes 19 are electrically connected to the pixel electrodes 16 through contact holes 26 formed by providing openings in the overcoat layer 34, the CF layers and the protective film 32 on the storage capacitor electrodes 19.

In the present embodiment, the pixel electrodes 16 are formed such that they cover the gate bus lines 12 and the drain bus lines 14. Therefore, even when there is a relative misalignment between a pixel electrode 16 and a drain bus line 14, the distance between the pixel electrode 16 and the drain bus line 14 will not change. Thus, the parasitic capacity will not change. Even when a pixel electrode 16 and a drain bus line 14 are formed with different widths at a boundary of exposure areas because of a misalignment at each shot of exposure, there will be no change in the distance between the pixel electrode 16 and the drain bus line 14. Any change in the parasitic capacity is thus prevented.

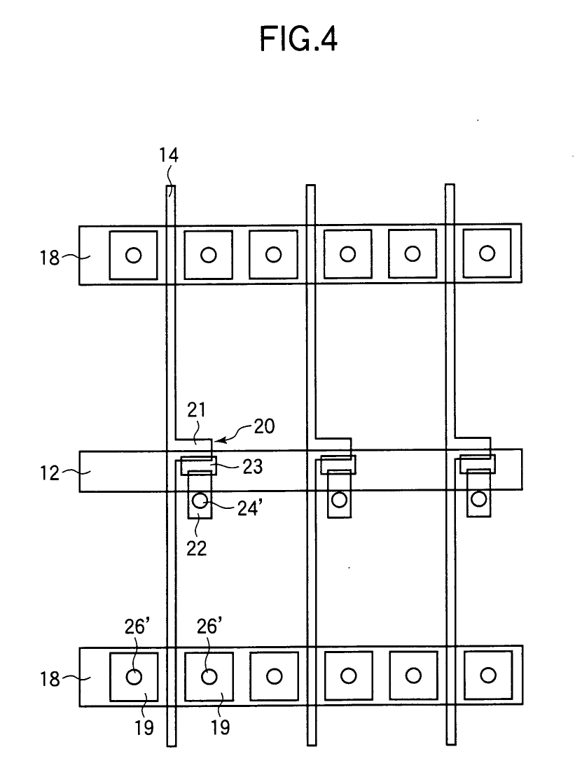

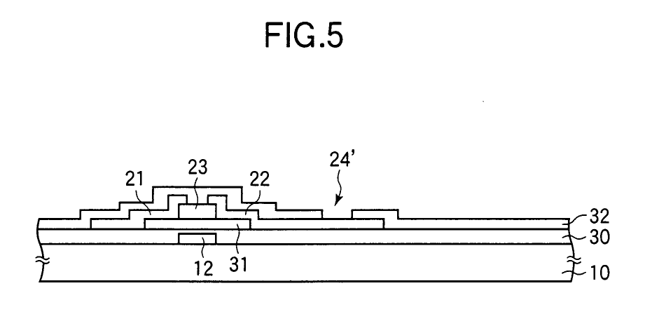

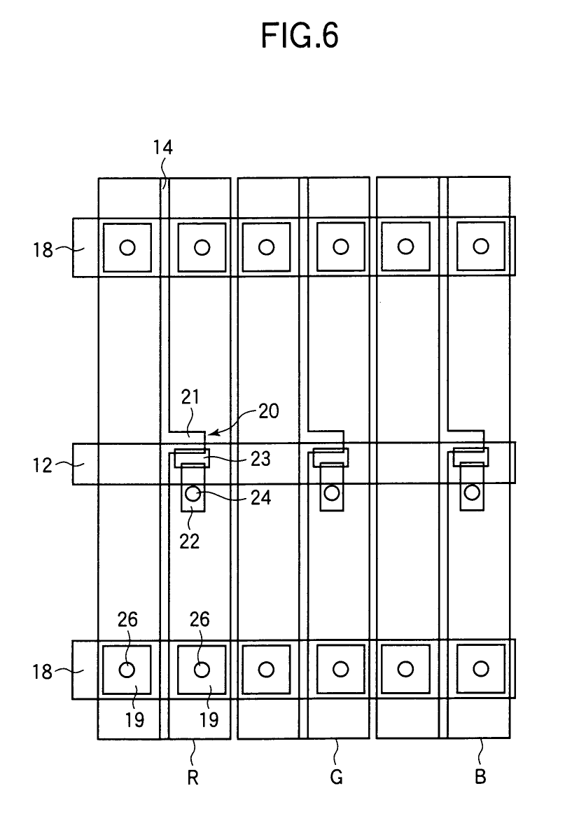

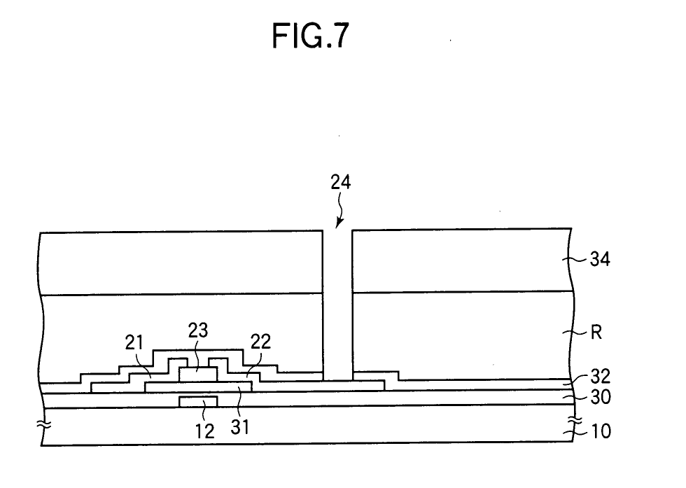

A description will now be made with reference to FIGS. 4 to 7 on a method of manufacturing a substrate for a liquid crystal display according to the present embodiment. FIGS. 4 and 6 show a method of manufacturing a TFT substrate. FIGS. 5 and 7 are sectional views taken in processes illustrating the method of manufacturing a TFT substrate, the section corresponding to that in FIG. 3A. First, as shown in FIGS. 4 and 5, gate bus lines 12 and storage capacitor bus lines 18 are formed on a glass substrate 10. For example, the gate bus lines 12 and the storage capacitor bus lines 18 are constituted by a single layer of chromium (Cr) or an aluminum (Al)/titanium (Ti) laminated layer, Al/molybdenum (Mo)/molybdenum nitride (MoN) laminated layer or Ti/Al/Ti laminated layer or the like.

Next, for example, a silicon nitride film (SiN film) is formed on the gate bus lines 12 and the storage capacitor bus lines 18 throughout the substrate to provide an insulation film 30. Active semiconductor layers 31 made of, for example, amorphous silicon (a-Si) are then formed on the insulation film 30. Channel protection films 23 constituted by, for example, SiN films are formed on the active semiconductor layers 31. The channel protection films 23 are formed on a self-alignment basis through back exposure using the gate bus lines12 as masks. Next, n⁺a-Si films and metal layers are formed in that order on the channel protection films 23 throughout the substrate and are patterned to form drain electrodes 21 and source electrodes 22 of the TFTs 20. At the same time, drain bus lines 14 and storage capacitor electrodes 19 are formed. For example, a single layer of Cr or an Al/Ti laminated layer, Al/Mo/MoN laminated layer or Ti/Al/Ti laminated layer or the like is used as the metal layer. For example, a SiN film is then formed on the drain electrodes 21, the source electrodes 22, the drain bus lines 14, and the storage capacitor electrodes 19 throughout the substrate to provide a protective film 32. Next, openings are provided in the protective film 32 on the source electrodes 22 to form contact holes 24′, and openings are provided in the protective film 32 on the storage capacitor electrodes 19 to form contact holes 26′.

Next, CF layers R, G and B are sequentially formed on the protective film 32 as shown in FIGS. 6 and 7. An overcoat layer 34 is then formed on the CF layers R, G and B throughout the substrate. Then, openings are provided in the overcoat layer 34 and the CF layers R, G and B above the contact holes 24′ to form contact holes 24, and openings are provided in the overcoat layer 34 and the CF layers R, G and B above the contact holes 26′ to form contact holes 26. Next, a film of a light-transmitting electrode material such as ITO is formed on the overcoat layer 34 throughout the substrate and patterned to form pixel electrodes 16 such that they cover the gate bus lines 12 and the drain bus lines 14. The pixel electrodes 16 are electrically connected to the source electrodes 22 through the contact holes 24 and are electrically connected to the storage capacitor electrodes 19 through the contact holes 26. A TFT substrate 2 as shown in FIGS. 2 to 3B is completed through the above-described steps. Thus, the substrate for a liquid crystal display according to the embodiment involves any increase in neither manufacturing steps nor manufacturing cost compared to a substrate for a liquid crystal display according to the related art.

[Second Embodiment]

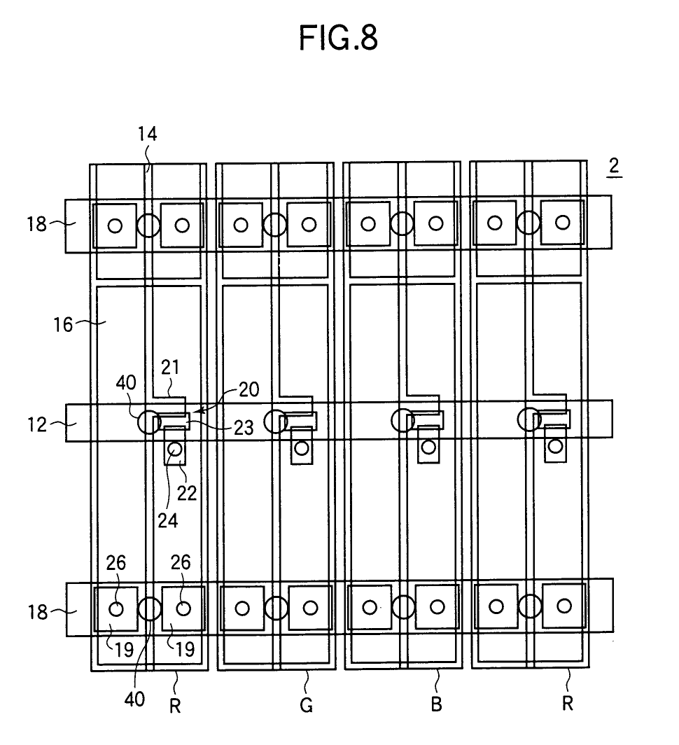

A description will now be made with reference to FIGS. 8 to 10 on a substrate for a liquid crystal display according to a second embodiment of the invention. FIG. 8 shows a configuration of a TFT substrate (base substrate) according to the present embodiment. As shown in FIG. 8, a TFT substrate 2 has a plurality of protrusions 40 to serve as alignment regulating structures and constitutes one of substrates of an MVA normally black mode liquid crystal display, for example. For example, the protrusions 40 are formed of a resist and are in a substantially circular configuration when viewed in a direction perpendicular to a surface of the substrate. The protrusions 40 are provided above positions where gate bus lines 12 and drain bus lines 14 intersect each other and above positions where storage capacitor bus lines 18 and the drain bus lines 14 intersect each other.

In the present embodiment, the protrusions 40 are formed in regions that do not contribute to the numerical aperture such as the positions where the gate bus lines 12 and the drain bus lines 14 intersect and the positions where the storage capacitor bus lines 18 and the drain bus lines 14 intersect. This makes it possible to achieve the same advantages as those of the first embodiment and to provide a liquid crystal display having a wide viewing angle without reducing the aperture ratio. The protrusions 40 may be formed on an opposite substrate 4.

Since the liquid crystal display of the present embodiment is in the normally black mode, there is no need for blocking light between pixel regions adjacent to each other. Since it is therefore not necessary to form a light-blocking film on the opposite substrate 4, the aperture ratio can be improved further. Since high accuracy of alignment is not required in combining the substrates 2 and 4, manufacturing processes can be simplified.

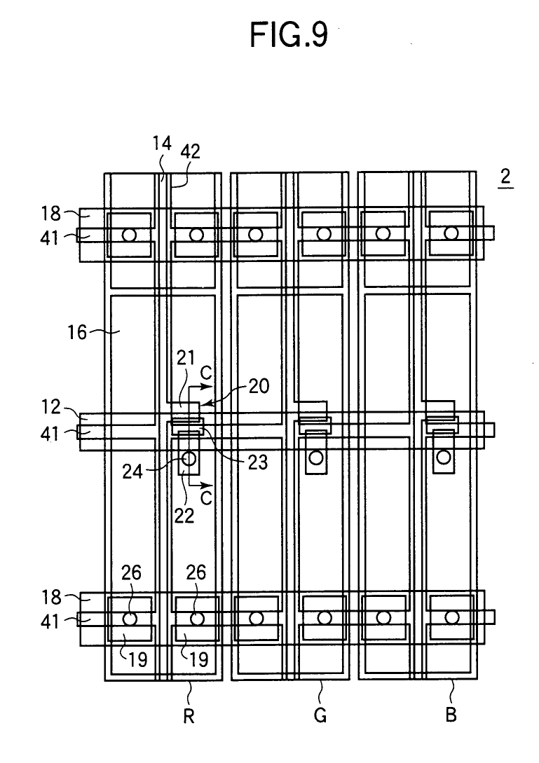

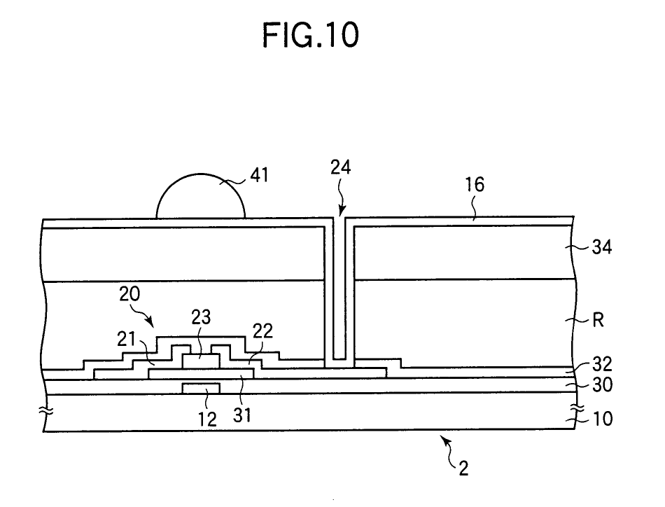

A description will now be made with reference to FIGS. 9 and 10 on a modification of the substrate for a liquid crystal display according to the present embodiment. FIG. 9 shows a configuration of a TFT substrate according to the present modification, and FIG. 10 shows a configuration of a section of the TFT substrate along the line C-C in FIG. 9. As shown in FIGS. 9 and 10, a TFT substrate 2 has a plurality of linear protrusions 41 extending in the horizontal direction in the figure and a plurality of linear protrusions 42 extending in the vertical direction in the figure, the protrusions serving as alignment regulating structures. The linear protrusions 41 are formed above gate bus lines 12 and storage capacitor bus lines 18. The linear protrusions 42 are formed above drain bus lines 14. In the present modification, the linear protrusions 41 and 42 are formed in regions above the gate bus lines 12, the drain bus lines 14 and the storage capacitor bus lines 18 the regions contributing nothing to the aperture ratio. This makes it possible to provide the same advantages as those of the above-described embodiment. The linear protrusions 41 and 42 may be formed on an opposite substrate 4.

[Third Embodiment]

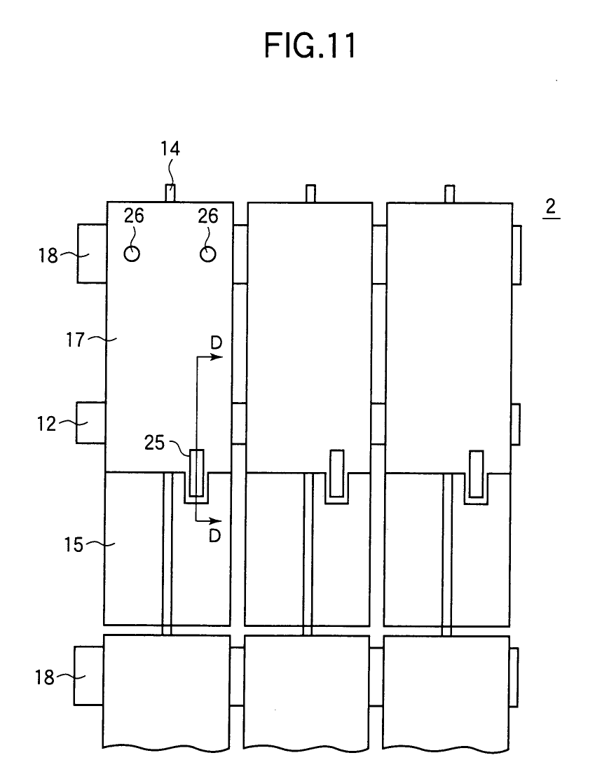

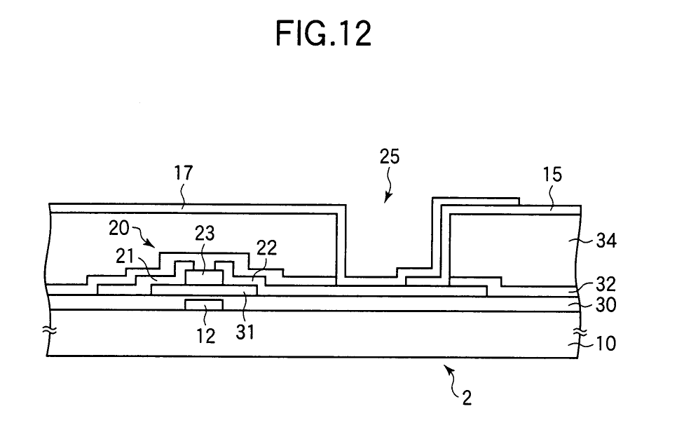

A description will now be made with reference to FIGS. 11 to 18B on a substrate for a liquid crystal display according to a third embodiment of the invention. FIG. 11 shows a configuration of a TFT substrate (base substrate) according to the present embodiment, and FIG. 12 shows a configuration of a section of the TFT substrate along the line D-D in FIG. 11. As shown in FIGS. 11 and 12, the TFT substrate 2 has a transparent electrode 15 made of a light-transmitting electrode material and a reflective electrode 17 made of a light-reflecting electrode material in each pixel and constitutes one of substrates of a transflective liquid crystal display. The transparent electrodes 15 and the reflective electrodes 17 in one pixel are electrically connected to each other. The transparent electrodes 15 transmit light impinging thereupon from a backlight unit 88 provided on a backside of the TFT substrate 2 toward a top side of the same, and the reflective electrode 17 reflect external light that impinges thereupon from the top side of the TFT substrate 2 (from the side of an opposite substrate 4). The reflective electrodes 17 are provided in upper parts of pixel regions in FIG. 11, and the transparent electrodes 15 are provided in lower parts of the same. The reflective electrodes 17 are formed such that they cover gate bus lines 12, storage capacitor bus lines 18, drain bus lines 14 and TFTs 20. The reflective electrodes 17 are electrically connected to source electrodes 22 of the TFTs 20 through contact holes 25. The reflective electrodes 17 are electrically connected to storage capacitor electrodes 19 (not shown in FIGS. 11 and 12) through contact holes 26.

The transparent electrodes 15 are formed such that they cover the drain bus lines 14. The transparent electrodes 15 are electrically connected to the source electrodes 22 of the TFTs 20 through contact holes 25.

In the present embodiment, the same advantages as those in the first embodiment are achieved, and the transparent electrodes 15 and the reflective electrodes 17 can be efficiently provided to achieve an improved aperture ratio by forming the reflective electrodes 17 such that they cover the gate bus lines 12, the storage capacitor bus lines 18 and the TFTs 20.

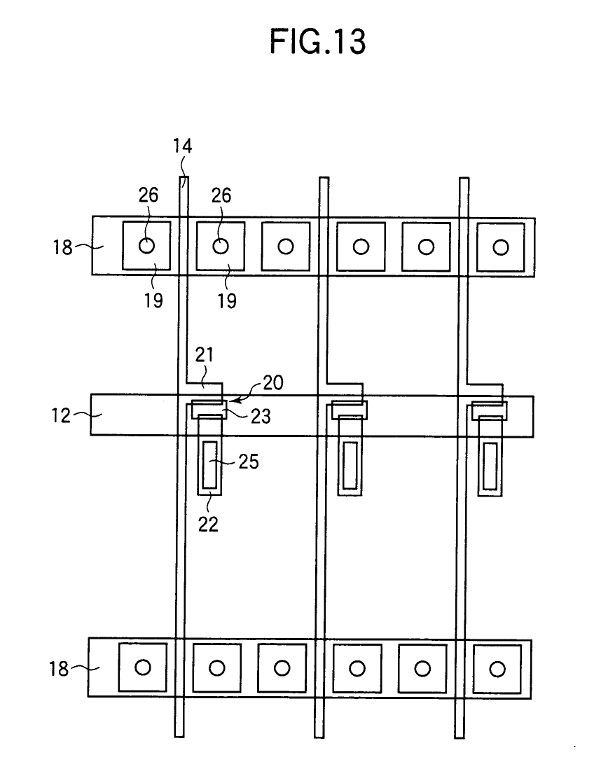

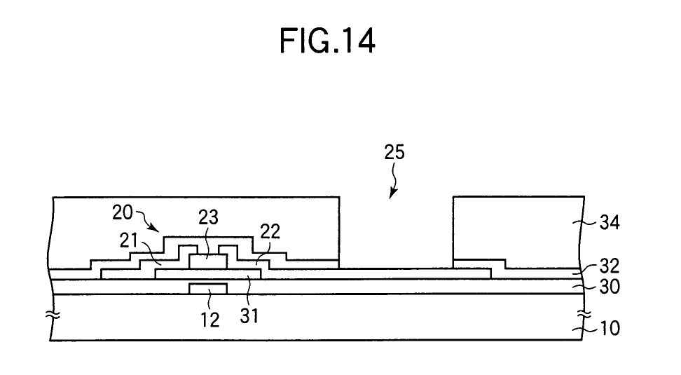

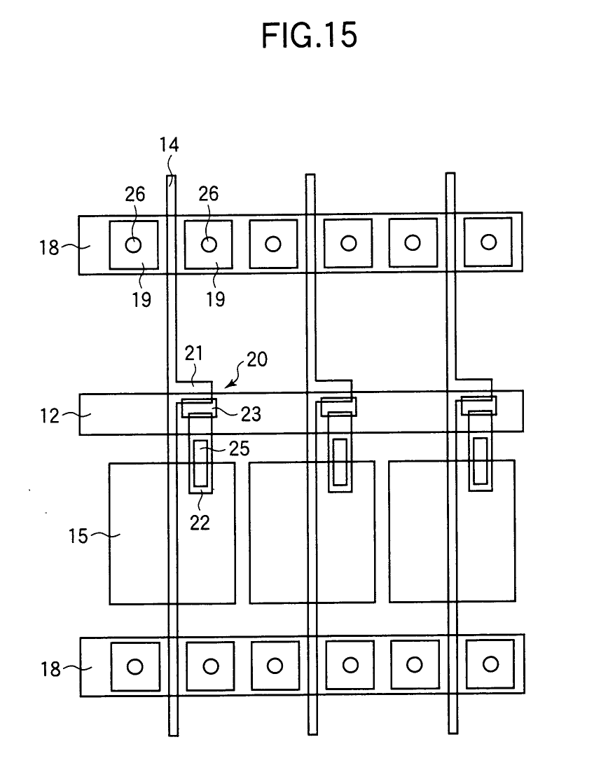

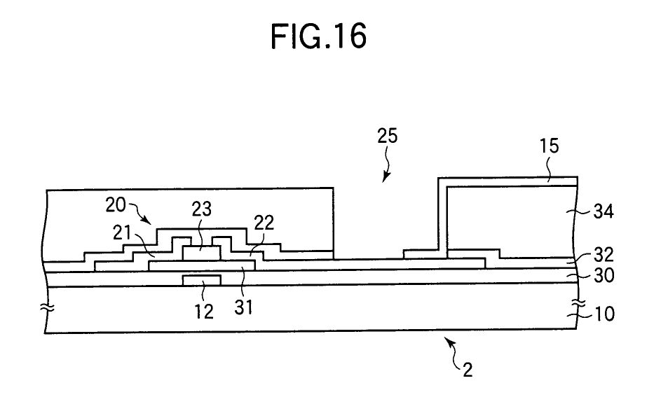

A description will now be then made with reference to FIGS. 13 to 16 on a method of manufacturing a substrate for a liquid crystal display according to the present embodiment. FIGS. 13 and 15 show the method of manufacturing a TFT substrate. FIGS. 14 and 16 are sectional views taken in processes showing the method of manufacturing a TFT substrate, the section corresponding to that shown in FIG. 12. First, as shown in FIGS. 13 and 14, gate bus lines 12 and storage capacitor bus lines 18 are formed on a glass substrate 10.

For example, a SiN film is then formed on the gate bus lines 12 and the storage capacitor bus lines 18 throughout the substrate to provide an insulation film 30. Next, active semiconductor layers 31 made of, for example, a-Si is formed on the insulation film 30. Next, channel protection films 23 constituted by, for example, SiN films are formed on the active semiconductor layer 31. Next, n⁺a-Si films and metal films are formed in that order on the channel protection films 23 throughout the substrate and patterned to form drain electrodes 21 and source electrodes 22 of TFTs 20. At the same time, drain bus lines 14 and storage capacitor electrodes 19 are formed. For example, a SiN film is then formed on the drain electrodes 21, the source electrodes 22, the drain bus lines 14 and the storage capacitor electrodes 19 throughout the substrate to provide a protective film 32. For example, a photosensitive resin is then applied to the protective film 32 throughout the substrate to form an overcoat layer 34. Next, openings are provided in the overcoat layer 34 and the protective film 32 on the source electrodes 22 to form contact holes 25, and openings are provided in the overcoat layer 34 and the protective film 32 on the storage capacitor electrodes 19 to form contact holes 26.

Next, as shown in FIGS. 15 and 16, a film of a light-transmitting electrode material such as ITO is formed on the overcoat layer 34 throughout the substrate and patterned to form transparent electrodes 15 such that they cover the drain bus lines 14. The transparent electrodes 15 are electrically connected to the source electrodes 22 through the contact holes 25.

A film of a light-reflective electrode material is then formed on the transparent electrodes 15 throughout the substrate and patterned to form reflective electrodes 17 such that they cover the gate bus lines 12, the storage capacitor bus lines 18 and the drain bus lines 14. A reflective electrode 17 is formed such that a part of the same overlaps a part of a transparent electrode 15, and the electrodes 16 and 17 in one pixel are electrically connected to each other. The reflective electrodes 17 are electrically connected to the source electrodes 22 through the contact holes 25 and are electrically connected to the storage capacitor electrodes 19 through the contact holes 26. A TFT substrate 2 as shown in FIGS. 11 and 12 are completed through the above-described steps. Thus, the substrate for a liquid crystal display according to the embodiment involves any increase in neither manufacturing steps nor manufacturing cost compared to a substrate for a liquid crystal display according to the related art.

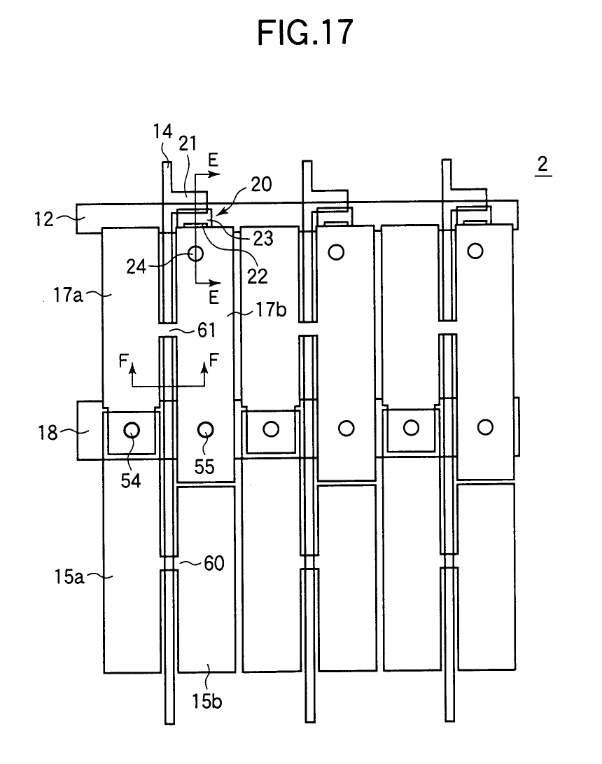

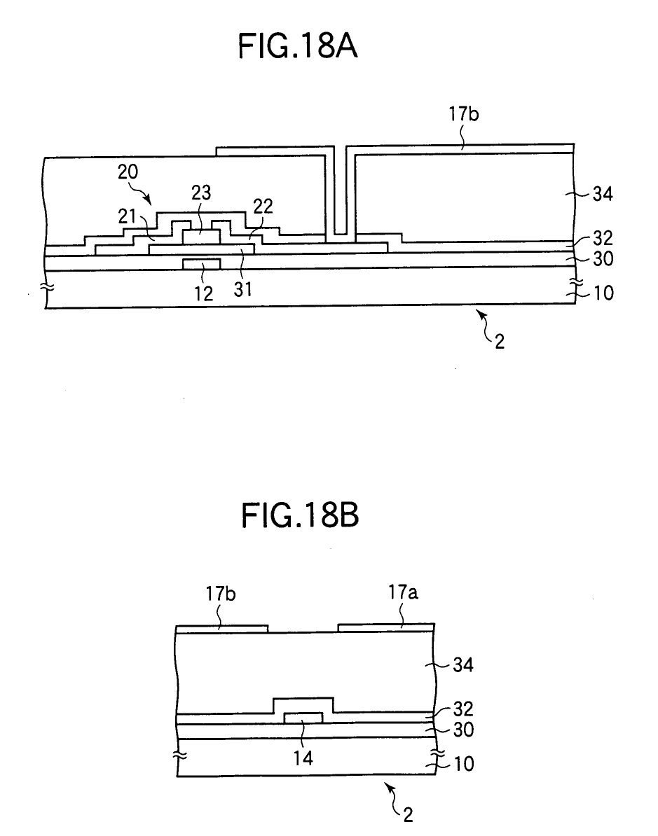

A description will now be made with reference to FIGS. 17 to 18B on a modification of the substrate for a liquid crystal display according to the present embodiment. FIG. 17 shows a configuration of a TFT substrate according to the present modification. FIG. 18A shows a configuration of a section of the TFT substrate along the line E-E in FIG. 17, and FIG. 18B shows a configuration of a section of the TFT substrate along the line F-F in FIG. 17. As shown in FIGS. 17 to 18B, a TFT substrate 2 has two reflective electrodes 17a and 17b and two transparent electrodes 15a and 15b in each pixel and constitutes one of substrates of a transflective liquid crystal display.

The reflective electrodes 17a and 17b are provided such that they sandwich a drain bus line 14 with predetermined gaps left therebetween when viewed in a direction perpendicular to a surface of the substrate. The reflective electrodes 17a and 17b are formed such that they cover storage capacitor bus lines 18. The reflective electrodes 17a and 17b are electrically connected to each other through a connecting electrode 61. The connecting electrodes 61 are formed of the same material as that of the reflective electrodes 17a and 17b. The reflective electrodes 17b are electrically connected to source electrodes 22 of TFTs 20 through contact holes 24 formed by providing openings in an overcoat layer 34 and a protective film 32 on the reflective electrodes 17b.

Although not shown, two storage capacitor electrodes 19 are formed on the storage capacitor bus line 18 in each pixel region, the electrodes 19 being provided such that they sandwich the drain bus line 14 with predetermined gaps left therebetween. The reflective electrode 17a is electrically connected to one of the storage capacitor electrodes 19 through a contact hole 54 formed by providing an opening in the overcoat layer 34 and the protective film 32 on the storage capacitor electrode 19. The reflective electrode 17b is electrically connected to the other storage capacitor electrode 19 through a contact hole 55 formed by providing an opening in the overcoat layer 34 and the protective film 32 on the storage capacitor electrode 19.

The transparent electrodes 15a are formed such that they cover the storage capacitor bus lines 18 and are connected to the reflective electrodes 17a on the storage capacitor bus lines 18. The transparent electrodes 15b are electrically connected to the transparent electrodes 15a through connecting electrodes 60. The present modification provides the same advantages as those of the above-described embodiment.

[Fourth Embodiment]

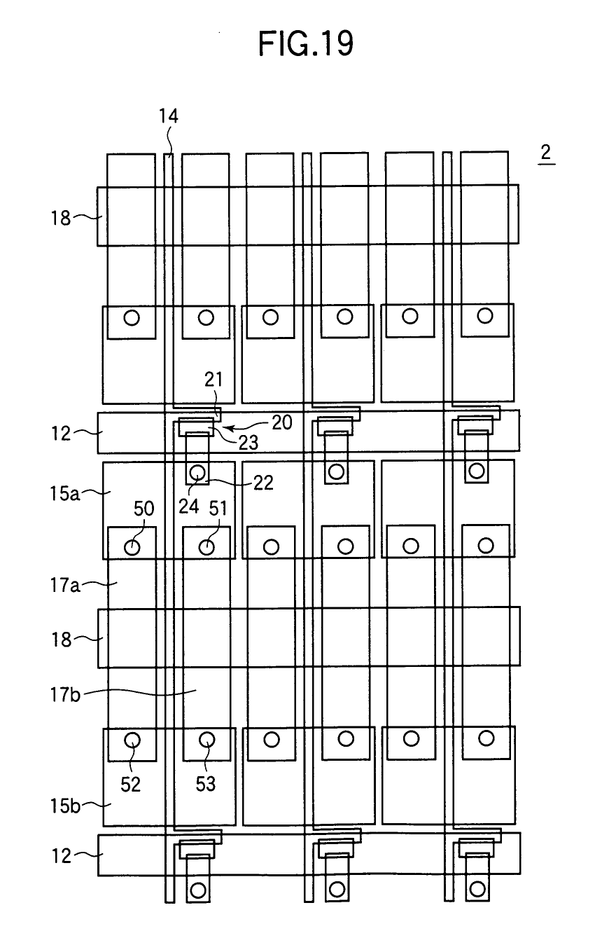

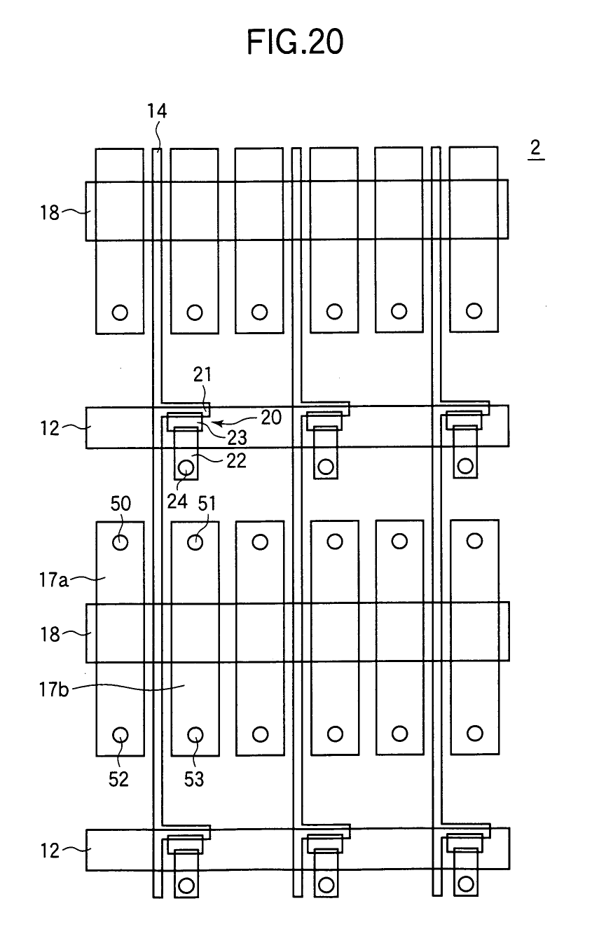

A description will now be made with reference to FIGS. 19 and 20 on a substrate for a liquid crystal display according to a fourth embodiment of the invention. FIG. 19 shows a configuration of a TFT substrate (base substrate) according to the present embodiment. As shown in FIG. 19, a TFT substrate 2 has two transparent electrodes 15a and 15b and two reflective electrodes 17a and 17b in each pixel and constitutes one of substrates of a transflective liquid crystal display.

The transparent electrodes 15a are formed such that they cover drain bus lines 14 and are electrically connected to source electrodes 22 of TFTs 20 through contact holes 24. The reflective electrodes 17a are formed such that they cover storage capacitor bus lines 18 and are electrically connected to the transparent electrodes 15a through contact holes 50. The reflective electrodes 17b are formed such that they cover the storage capacitor bus lines 18 and are electrically connected to the transparent electrodes 15a through contact holes 51. The transparent electrodes 15b are formed such that they cover the drain bus lines 14. The transparent electrodes 15b are electrically connected to the reflective electrodes 17a through contact holes 52 and are electrically connected to the reflective electrodes 17b through contact holes 53.

The reflective electrodes 17a and 17b are formed of the same material as that of the drain bus lines 14 and are provided such that they sandwich the drain bus lines 14 with predetermined gaps left therebetween. The reflective electrodes 17a and 17b are provided opposite to the storage capacitor bus lines 18 with an insulation film 30 that are dielectric layers interposed therebetween and function as electrodes for a storage capacitor formed in each of pixel regions.

A description will now be made with reference to FIG. 20 in a method of manufacturing a substrate for a liquid crystal display according to the present embodiment. Steps up to the formation of channel protection films 23 of TFTs 20 will not be described because they are similar to those of the first and third embodiments. Drain electrodes 21 and source electrodes 22 of the TFTs 20 are formed by forming n⁺a-Si films and metal layers in that order on the channel protection films 23 throughout the substrate and patterning the same. At the same time, drain bus lines 14 and reflective electrodes 17a and 17b are formed. Next, for example, a SiN film is then formed on the drain electrodes 21, the source electrodes 22, the drain bus lines 14, and the reflective electrodes 17a and 17b throughout the substrate to provide a protective film 32 (not shown in FIG. 20). Next, for example, a photosensitive resin is then applied to the protective film 32 throughout the substrate to form an overcoat layer 34 (not shown in FIG. 20). Next, openings are provided in the overcoat layer 34 and the protective film 32 on the source electrodes 22 to form contact holes 24. At the same time, openings are provided in the overcoat layer 34 and the protective film 32 on the reflective electrodes 17a to form contact holes 50 and 52, and openings are provided in the overcoat layer 34 and the protective film 32 on the reflective electrodes 17b to form contact holes 51 and 53.

Next, a film of a light-transmitting electrode material such as ITO is formed on the overcoat layer 34 throughout the substrate and patterned to form transparent electrodes 15a and 15b such that they cover the drain bus lines 14. The transparent electrodes 15a are electrically connected to the reflective electrodes 17a through the contact holes 50 and are electrically connected to the reflective electrodes 17b through the contact holes 51. The transparent electrodes 15b are electrically connected to the reflective electrodes 17a through the contact holes 52 and are electrically connected to the reflective electrodes 17b through the contact holes 53. A TFT substrate 2 as shown in FIG. 19 is completed through the above-described steps.

In the present embodiment, the reflective electrodes 17a and 17b are formed of the same material as that of the drain bus lines 14 at the same time. Therefore, the present embodiment provides the same advantages as those of the first embodiment and makes it possible to manufacture a TFT substrate 2 for a transflective liquid crystal display using photo-masks in the same quantity as that for a TFT substrate 2 used in a common transmissive liquid crystal display.

[Fifth Embodiment]

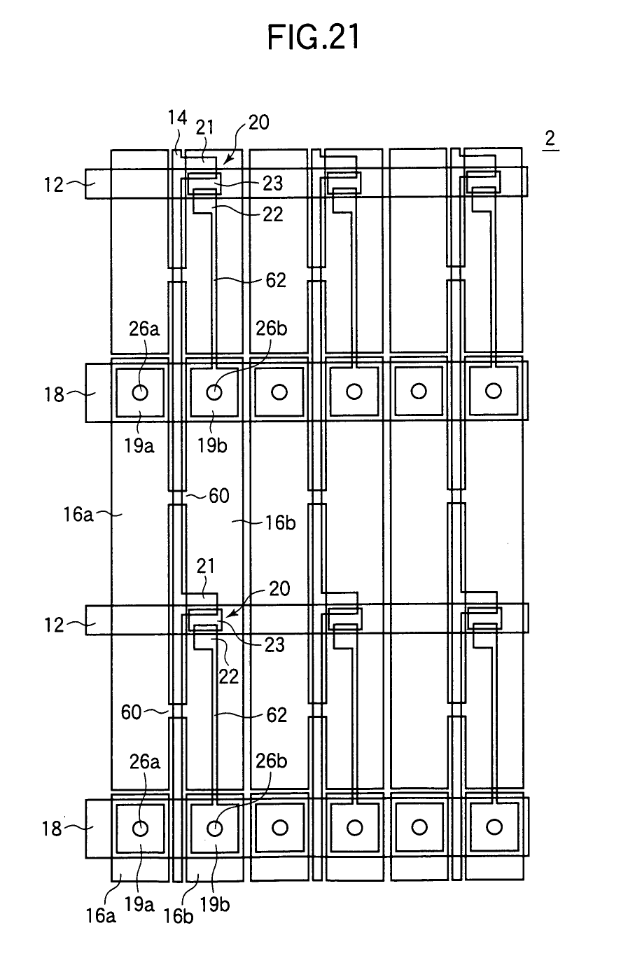

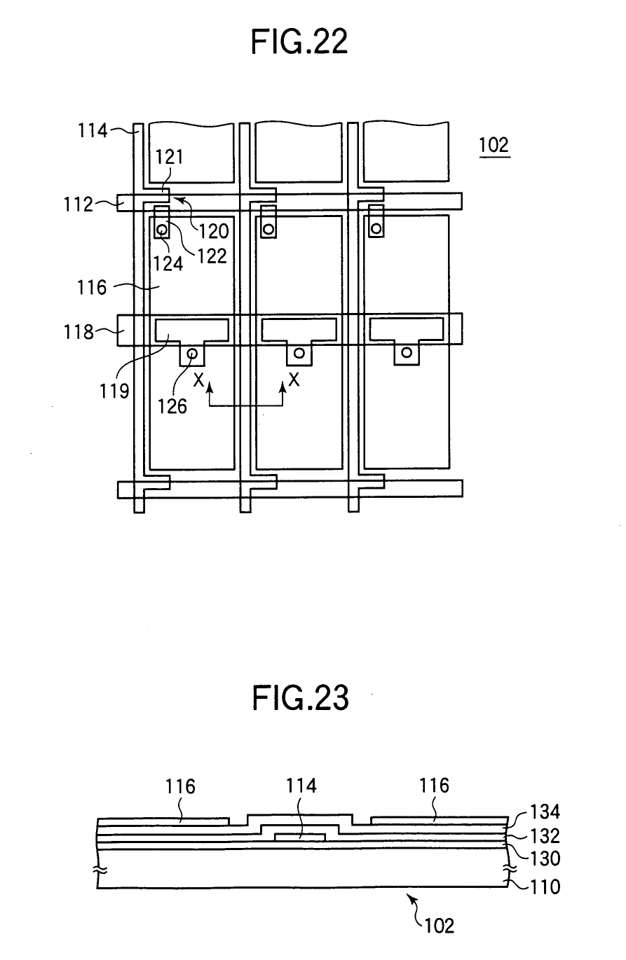

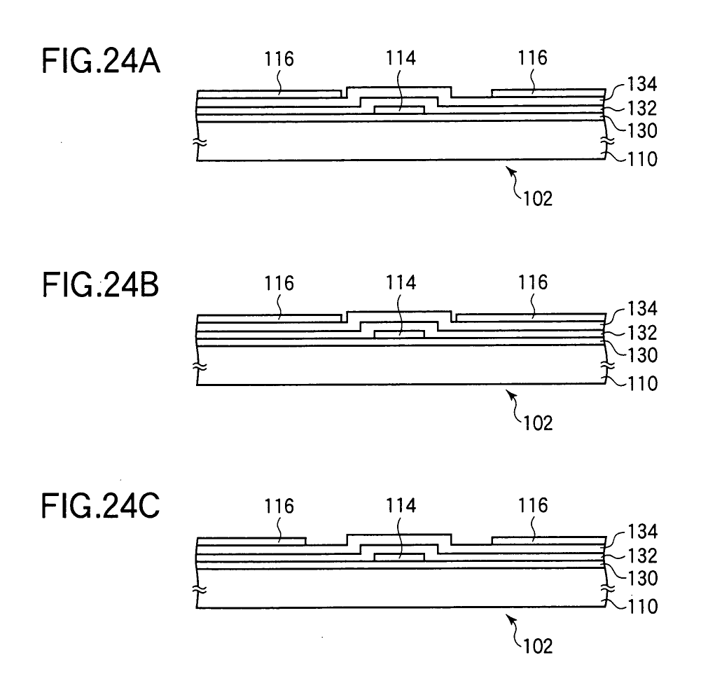

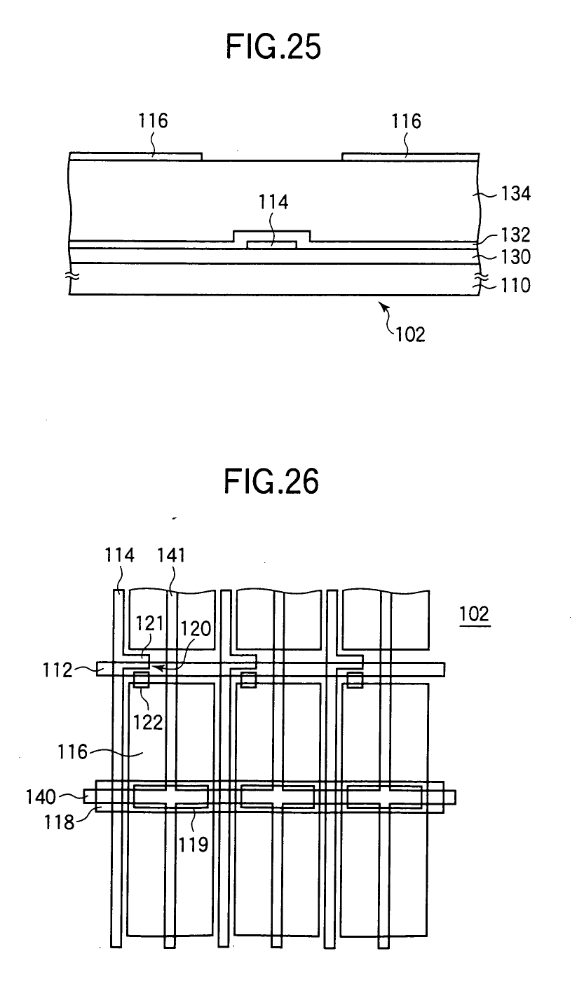

A description will now be made with reference to FIG. 21 on a substrate for a liquid crystal display according to a fifth embodiment of the invention. FIG. 21 shows a configuration of a TFT substrate (base substrate) according to the present embodiment. As shown in FIG. 21, a TFT substrate 2 has two pixel electrodes 16a and 16b and connecting electrodes 60 for electrically connecting the pixel electrodes 16a and 16b in each pixel.

The pixel electrodes 16a and 16b are formed such that they cover gate bus lines 12 and storage capacitor bus lines 18. The pixel electrodes 16a and 16b are provided such that they sandwich the drain bus lines 14 with predetermined gap left therebetween when viewed in the direction perpendicular to a surface of the substrate. The pixel electrodes 16a and 16b are electrically connected to each other through two connecting electrodes 60. The connecting electrodes 60 are formed of the same material as that of the pixel electrodes 16a and 16b.

Two storage capacitor electrodes 19a and 19b are formed on the storage capacitor bus line 18 in each pixel region. The storage capacitor electrodes 19a and 19b are provided on both sides of respective drain bus lines 14. The storage capacitor electrodes 19a are electrically connected to the pixel electrodes 16a through contact holes 26a formed by providing openings in an overcoat layer 34 and a protective film 32 (both of which are not shown in FIG. 21) on the storage capacitor electrodes 19a. The storage capacitor electrodes 19b are electrically connected to the pixel electrodes 16b through contact holes 26b formed by providing openings in the overcoat layer 34 and the protective film 32 on the storage capacitor electrodes 19b.

A source electrode 22 of a TFT 20 is connected through a connection wiring 62 to the storage capacitor electrode 19b in the adjacent pixel located below the same in FIG. 21 rather than the pixel where the TFT resides. That is, a gate electrode of a TFT 20 is electrically connected to one of two adjacent gate bus lines 12 that is located upper in the figure, and the source electrode 22 of the same TFT 20 is electrically connected to the pixel electrodes 16a and 16b which are provided to cover the lower one of the two adjacent gate bus lines 12 in the figure. The connection wiring 62 is formed of the same material as that of the drain bus lines 14, drain electrodes 21, the source electrodes 22, and the storage capacitor electrodes 19a and 19b.

In the present embodiment, the pixel electrodes 16a and 16b are formed such that they cover the TFT 20 and the gate bus line 12 for driving the adjacent pixel that is located below in the figure. So, this makes it possible to achieve the same advantages as those of the first embodiment. When a predetermined potential is written in the pixel electrodes 16a and 16b, no voltage is applied to the gate bus lines 12 located below the pixel electrodes 16a and 16b, and a voltage is applied to the adjacent gate bus lines 12 located above them. Since the pixel potential is not affected by electric fields originating from the gate bus lines 12, it is possible to prevent the occurrence of flickers or a luminance gradient or the like on a display screen.

The invention is not limited to the above-described embodiments and may be modified in various ways.

For example, while substrates for bottom gate type liquid crystal displays are referred to as examples in the above-described embodiments, the invention is not limited to them and may be applied to substrates for top gate type liquid crystal displays.

While substrates for channel-protected liquid crystal displays are referred to as examples in the above-described embodiments, the invention is not limited to them and may be applied to substrates for channel-etched liquid crystal displays.

In the above-described embodiment, an overcoat layer 34 is formed on a protective film 32 to reduce parasitic capacities. According to the invention, however, substantially equal parasitic capacities are generated between gate bus lines 12 or drain bus lines 14 and pixel electrodes 16 (that include transparent electrodes 15 and reflective electrodes 17) at all pixels in a display area, and there is no variation of the parasitic capacity attributable to misalignment. Therefore, no display irregularity is visually perceived even when the overcoat 34 is not formed.

As described above, the invention makes it possible to provide a liquid crystal display that can be manufactured through simplified manufacturing processes and that can provide high display quality.

1. A substrate for a liquid crystal display, comprising:
a base substrate that sandwiches a liquid crystal in combination with an opposite substrate provided opposite to the same;
first and second bus lines formed on the base substrate such that they intersect each other with an insulation film interposed therebetween; and
a pixel electrode provided so as to cover a full width of a portion of at least one of the first and second bus lines with a dielectric layer interposed therebetween and forming a parasitic capacity between the first or second bus line and itself.

2. A substrate for a liquid crystal display according to claim 1, further comprising an alignment regulating structure for regulating the alignment of the liquid crystal, wherein the alignment regulating structure is provided on any one of the first and second bus lines when viewed in a direction perpendicular to a surface of the base substrate.

3. A substrate for a liquid crystal display according to claim 1, wherein the pixel electrode comprises a transparent electrode that is formed of a light-transmitting material and that transmits light impinging thereupon from a backside of the base substrate toward a top side of the base substrate and a reflective electrode that is electrically connected to the transparent electrode and formed of a light-reflecting material and that reflects light impinging thereupon from the top side of the base substrate.

4. A substrate for a liquid crystal display according to claim 3, wherein the reflective electrode functions as an electrode for a storage capacitor formed at each of pixel regions.

5. A substrate for a liquid crystal display according to claim 3, wherein the reflective electrode is formed of the same material as that of the first or second bus line.

6. A substrate for a liquid crystal display according to claim 1, wherein the pixel electrode is provided such that it overlaps the first or second bus line substantially in the middle thereof when viewed in a direction to the surface of the substrate.

7. A substrate for a liquid crystal display according to claim 1, further comprising:
a thin film transistor that is formed in the vicinity of a position where the first and second bus lines intersect and that has a gate electrode electrically connected to the first bus line, a drain electrode electrically connected to the second bus line, and a source electrode electrically connected to the pixel electrode, wherein the gate electrode is electrically connected to one of a pair of the first bus lines that are adjacent to each other and wherein the source electrode is electrically connected to the pixel electrode that is provided such that it covers the other of the first bus lines adjacent to each other.

8. A liquid crystal display comprising a pair of substrates and a liquid crystal sealed between the pair of substrates wherein a substrate for a liquid crystal display according to claim 1 is used as one of the substrates.
